(19) United States
(12) Patent Application Publication
(10) Pub. No.: US 2004/0166321 A1
(43) Pub. Date: Aug. 26, 2004

(54) Non-slip portable absorbent article

(76) Inventors: Carl G. Rippl, Appleton, WI (US); Susan M. Trefethren, Appleton, WI (US); Anita M. Banjak, Menasha, WI (US)

Correspondence Address: KIMBERLY-CLARK WORLDWIDE, INC., 401 NORTH LAKE STREET, NEENAH, WI, 54956

(21) Appl. No.: 10/370,683

(22) Filed: Feb. 21, 2003

(51) Int. Cl. B32B 9/04

(52) U.S. Cl. 428/411.1

(57) ABSTRACT

A disposable absorbent article having an inner surface and an outer surface. The disposable absorbent article includes an absorbent layer disposed toward the inner surface and a film layer adjacent the absorbent layer where the film layer provides at least a portion of the outer surface of the disposable absorbent article with a static coefficient of friction of at least 0.5 as defined by the coefficient of friction test set forth herein.

### FIELD OF THE INVENTION

The present invention relates to absorbent articles, desirably disposable absorbent articles such as disposable changing pads that have a distinctive non-slip backing.

### BACKGROUND OF THE INVENTION

It is often necessary to care for an infant or small child in a mobile setting. In such situations, it is often desirable to protect the infant or child from the surroundings, and in turn protect the surroundings from any bodily exudates that may be present. As such, an article that provides a suitable changing pads area is desired. Moreover, it is desired that such an article be portable and discreet.

In certain circumstances, reusable mats or pads have been employed in such instances by the caregiver to satisfy this need. However, this has not always been entirely satisfactory since reusable pads are often not absorbent. This lack of absorbency typically could lead to runoff of liquid exudates and require the undesirable storage of the soiled pad for later clean up. In addition, such reusable pads are often not capable of remaining repeatedly folded for compact storage.

Attempts have been made to provide disposable mats to alleviate some of the problems noted above. However, often these attempts have also not been entirely satisfactory. In particular, in order to provide a generally fluid impervious backing, many disposable changing pads have a slick backing that allow the pad to undesirably slide on the changing surface. This can complicate the changing process and potentially lead to injury of the baby or child.

Moreover, in order to make the disposable changing pad cost effective and ease portability, the pads are often small and cannot provide the surface area necessary to insulate the child or baby from the changing environment or protect the surroundings from bodily exudates.

Further, where changing pads or mats have included additional materials or coatings to reduce the slick nature of the liquid impervious backing, the drape stiffness of the pad often increases. The changing pad can be more difficult to fold or compress, and the ease of portability is compromised. Likewise, certain disposable changing pads include a bulky absorbent layer that further complicates the caregiver's ability to discreetly store such a pad. Further, such additional materials or coatings can increase the cost and manufacturing complexity of the article.

Accordingly, despite attempts made to provide appropriate absorbent articles, there remains a need for disposable absorbent articles that are suited for mobile use. That is, there remains a need for disposable changing pads that provide a non-slip backing and are easily portable yet provide an adequate changing surface area. Further, there remains a need for a changing pad that provides these features while providing a desirable level of absorbency.

### SUMMARY OF THE INVENTION

In response to the problems and difficulties discussed above, a new distinctive disposable absorbent article has been discovered. In one aspect, the present invention concerns a disposable absorbent article having an inner surface and an outer surface. The disposable absorbent article includes an absorbent layer disposed toward the inner surface and a film layer adjacent the absorbent layer where the film layer provides at least a portion of the outer surface of the disposable absorbent article with a static coefficient of friction of at least 0.5 as defined by the coefficient of friction test set forth herein.

In another aspect, the present invention concerns a disposable changing pad having an inner surface and an outer surface. The disposable absorbent article includes an absorbent layer disposed toward the inner surface and a film layer adjacent the absorbent layer where the film layer provides at least a portion of the outer surface of the changing pad with a static coefficient of friction of at least 0.5 as defined by the coefficient of friction test set forth herein and the changing pad defines a CD drape stiffness of less than 6.0 cm as defined by the drape stiffness test set forth herein.

In yet another aspect, the present invention concerns a disposable changing pad having an inner surface and an outer surface. The disposable absorbent article includes an absorbent layer disposed toward the inner surface and a film layer adjacent the absorbent layer where the film layer provides at least a portion of the outer surface of the changing pad with a static coefficient of friction of at least 0.5 as defined by the coefficient of friction test set forth herein, the outer surface of the changing pad defines a planar continuity of at least 90%, and the changing pad defines a CD drape stiffness of less than 6.0 cm as defined by the drape stiffness test set forth herein.

In still yet another aspect, the present invention concerns a disposable changing pad having an inner surface and an outer surface. The changing pad includes an absorbent layer disposed toward the inner surface and a film layer adjacent to said absorbent layer and disposed toward said outer surface where the changing pad defines a drape friction index of less than 6 cm as determined by the drape friction index test set forth herein.

Accordingly, the present invention advantageously provides a disposable absorbent article that has a secure, non-slip backing suitable for use when caring for a baby or child in a mobile environment. The present invention also advantageously includes an absorbent layer that may reduce the instance of runoff of liquid exudates and may reduce the need to clean up the surrounding area. In addition, the present invention may provide a particular absorbent capacity while maintaining a thickness dimension that is between 0.8 mm and 1.2 mm. As such, the present invention may advantageously provide the desired absorbent attributes while remaining highly portable. Moreover, this benefit may be enhanced by the low drape stiffness of the present invention, which further increases the ability of the caregiver to reduce the article's size prior to use. Thus the present invention provides a disposable absorbent article that provides a non-slip surface, a suitable absorbent layer and that may be greatly reduced in size for improved portability.

It is understood that both the foregoing general description and the following detailed description are exemplary and are intended to provide further explanation of the invention claimed. The accompanying drawings, which are incorporated in and constitute part of this specification, are included to illustrate and provide a further understanding of the absorbent articles of the present invention. Together with the description, the drawings serve to explain the various aspects of the invention.

### BRIEF DESCRIPTION OF THE DRAWINGS

The present invention will be more fully understood and further advantages will become apparent when reference is made to the following detailed description of the invention and the accompanying drawings wherein like numerals represent like elements. The drawings are merely representative and are not intended to limit the scope of the appended claims.

FIG. 1 representatively illustrates a top plan view of an absorbent article of the present invention;

FIG. 2 representatively illustrates a section view of the absorbent article of FIG. 1 along line A-A.

### DETAILED DESCRIPTION OF THE INVENTION

The present invention is directed to solving the problems related to caring for an infant or a small child in a mobile environment, or when away from home. For example, the present invention is directed to solving the potential problem of slippage resulting from the use of a conventional changing pad having a slick backing. Moreover, the present invention is directed to solving the problem of bulky changing pads that are difficult to fold, and in addition, the invention is directed to solving the problem of small, disposable changing pads that have sacrificed article surface area to reduce cost and increase portability. Further, the present invention is directed to solving the possible problems related to the clean-up associated with conventional, non-disposable changing pads.

For example, conventional non-disposable changing pads are often bulky and are substantially non-absorbent and are thus difficult to fold and store, and often require additional clean-up of any leakage that may result. To address this issue, some changing pads may resort to using slick surfaces to ease the cleaning burden on the caregiver, but these surfaces may lead to undesired slippage by the pad. Conversely, disposable changing pads that are absorbent may also be thick and bulky due to the absorbent layer that is included. Finally, disposable pads may also have a slick, slippery backing material resulting from the desire to have a liquid impermeable layer. This problem has been addressed previously by applying an adhesive layer, or a layer having topography to impart friction. These add cost, process complexity, and increase rigidity, which may lead to increased drape stiffness and a reduced level of portability.

The present invention is directed to a disposable absorbent article, for example a disposable changing pad, that is particularly suited for use when the care for an individual must be administered outside or away from home. The changing pad is configured to be absorbent and provide a non-slip backing surface. In addition, the changing pad of the present invention may be configured to allow for compact storage while yet providing an ample surface area for use.

The disposable absorbent articles of the present invention will be described in terms of a disposable changing pad, adapted to be used with infants and small children. In particular, the disposable absorbent articles will be described in terms of a changing pad that includes an absorbent layer and a film layer that is adjacent the absorbent layer. Typically, disposable articles are intended for limited use and are not intended to be laundered or otherwise cleaned for reuse. It is understood that the articles of the present invention are equally adaptable for other types of absorbent articles such as bed pads, surgical drapes, adult incontinent products, feminine care products, items for medical kits, items for first aid kits, other personal care or health care garments, and the like.

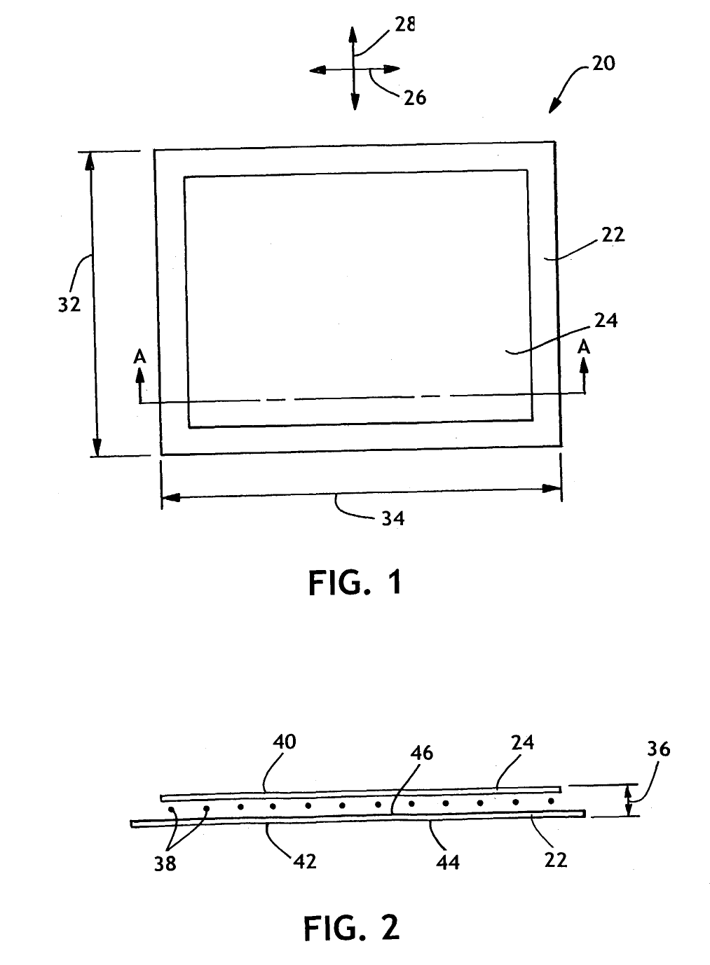

FIG. 1 representatively illustrates a changing pad 20 of the present invention. FIG. 2 representatively illustrates a section view of the changing pad 20 along section line A-A. As illustrated in FIG. 1, the changing pad of the present invention defines lateral direction 26, a longitudinal direction 28, a width 32, and a length 34. As representatively illustrated in FIG. 2, the changing pad also defines a thickness 36, an inner surface 40 and an outer surface 42 opposite the inner surface 40. In general, the inner surface 40 is that part of the changing pad 20 that faces the caregiver and user during use, and the outer surface 42 is that part of the changing pad 20 that contacts the surface upon which the changing pad is placed during use.

As representatively illustrated in FIGS. 1 and 2, the changing pad 20 of the present invention includes an absorbent layer 24 disposed toward the inner surface 40 of the changing pad and a film layer 22 located adjacent the absorbent layer 24. The film layer 22 may define a first surface 44 and a second surface 46, where the first surface 44 of the film layer 22 may be disposed toward the outer surface 42 of the changing pad 20, and the inner surface 40 of the film layer 22 may be disposed toward the absorbent layer 24. Thus, in certain aspects, the film layer 22 may be arranged to provide at least a portion of the outer surface 42 of the changing pad 20. Alternatively, the outer surface 42 of the changing pad 20 may be provided by another layer, coating, or material that may be attached or otherwise part of the changing pad 20.

The absorbent layer 24 and the film layer 22 may be substantially coextensive, or the absorbent layer 24 may be smaller than the film layer 22 in the lateral direction 26, the longitudinal direction 28, or both. For example, as representatively illustrated in FIG. 1, the absorbent layer 24 is smaller than the film layer in both the lateral direction 26 and the longitudinal direction 28. Alternatively, the absorbent layer 24 may also be configured to be larger than the film layer 22 in the lateral direction 26, the longitudinal direction 24, or both.

The outer surface 42 of the changing pad 20 may desirably have non-slip characteristics such that in use, there is a reduced opportunity for the changing pad 20 to slide off of the surface that it is placed upon. In addition, such non-slip characteristics can reduce the amount of bunching and shifting in the pad that could result from an active infant or child. In one alternative, the film layer 22 of the present invention may be suitably configured to provide at least a portion of the outer surface 42 of the changing pad 20 with the desired coefficient of friction. Alternatively, another layer, coating or material may provide the outer surface 42 with the desired coefficient of friction. In one embodiment, at least a portion of the outer surface 42 of the changing pad 20 has a static coefficient of friction of at least 0.5 as defined by the coefficient of friction test defined herein. Alternatively, at least a portion of the outer surface 42 of the changing pad 20 has a static coefficient of friction of at least 0.7 as defined by the coefficient of friction test defined herein. In another alternative, at least a portion of the outer surface 42 of the changing pad 20 with a static coefficient of friction of at least 1.5 as defined by the coefficient of friction test defined herein.

In addition, in certain aspects, it may be desired that the static coefficient of friction of the outer surface 42 be maintained below a particular level in order to allow the caregiver to more easily adjust the changing pad 20 while handling an infant or small child. Specifically, it may be desirable that at least a portion of the outer surface 42 of the changing pad 20 has a static coefficient of friction of between 0.5 and 2.0 as defined by the coefficient of friction test defined herein. More desirably, at least a portion of the outer surface 42 of the changing pad 20 has a static coefficient of friction of between 0.7 and 1.5 as defined by the coefficient of friction test defined herein. As mentioned above, the film layer 22 of the present invention may be suitably configured to provide at least a portion of the outer surface 42 of the changing pad 20 with the desired coefficient of friction range. Alternatively, another layer, coating or material may provide the outer surface 42 with the desired coefficient of friction range.

The desired static coefficient of friction may be imparted to the changing pad 20 of the present invention while maintaining a high level of planar continuity on the outer surface 42 of the changing pad. As used herein, the term “planar continuity” refers to a surface being substantially void of any additional materials or treatments. The planar continuity of a surface may be established by determining the area of a surface that is substantially void of any additional materials or treatments and dividing that area by the surface area of the entire surface, and finally multiplying that value by 100. Therefore, in a particular aspect, the outer surface 42 may exhibit a certain static coefficient of friction without any additional layers, coatings, materials or substantial rugosities or topography. Accordingly, in one aspect, the outer surface 42 may define a planar continuity of at least 85%. In another aspect, the outer surface 42 may define a planar continuity of at least 90%. In yet another aspect, the outer surface 42 may define a planar continuity of at least 95%.

When the changing pad 20 is in an open, laid flat configuration as illustrated in FIG. 1, it defines an open surface area that is bounded by the largest perimeter of the changing pad. The perimeter of the changing pad may be provided by the absorbent layer 24, the film layer 22, or any other layer, surface or material that may be attached or otherwise part of the changing pad 20, or combinations thereof. It should be noted that the changing pad 20 of the present invention may be various suitable shapes as are well known in the art. For example, the changing pad 20 may be rectangular, round, elliptical, trapezoidal, and the like. Desirably, the changing pad 20 is generally rectangular or square in shape for ease of manufacturability. Therefore, for the generally rectangular configuration illustrated in FIG. 1, the perimeter of the changing pad 20 is established by its width 32 and length 34. In non-rectangular configurations, the open surface area of the largest perimeter of the changing pad 20 is be determined using standard calculation methods as are well known in the art.

Desirably, the open surface area of the changing pad 20 is large enough to provide an ample surface area to separate the infant or child from the surrounding environment. For example, in one aspect, the open surface area of the changing pad may be at least 100 square inches. In another aspect the open surface area of the changing pad may be at least 250 square inches. In yet another aspect the open surface area of the changing pad may be at least 500 square inches. In still yet another aspect the open surface area of the changing pad may be at least 560 square inches. In a particular aspect the open surface area of the changing pad 20 of the present invention may be at least 600 square inches.

The changing pad 20 of the present invention may also define a folded surface area when it is in a folded configuration. Specifically, the folded surface area of the changing pad 20 is defined by the largest perimeter of the changing pad 20 that results when at least a portion of the changing pad is layered upon itself at least once to provide a folded configuration. Typically, the folded configuration of the changing pad 20 is obtained by layering the changing pad 20 upon itself in a series of folds until a convenient storage size is obtained to maximize discreetness and portability. In one aspect, the changing pad 20 of the present invention may define a folded surface area that is less than 20% of the open surface area of the changing pad 20 when the changing pad 20 is in a folded configuration. In another aspect, the changing pad 20 may define a folded surface area that is less than 10% of said open surface area. In yet another aspect, the changing pad 20 may define a folded surface area that is less than 5% of said open surface area.

To assist in achieving the desired folded configurations discussed above, the changing pad 20 of the present invention may exhibit a desired level of flexibility, or drape stiffness. In addition, an article having suitable levels of drape stiffness is generally more cloth-like and pleasant to the touch. Thus, a changing pad having a desirable drape stiffness can provide an improved perception of comfort to the user in addition to having improved folding characteristics. As such, the changing pad 20 may define a cross directional (CD) drape stiffness of less than 8.0 cm as defined by the drape stiffness test set forth herein, and more particularly, the changing pad 20 of the present invention may define a CD drape stiffness of less than 6.0 cm as defined by the drape stiffness test set forth herein.

In a particular aspect, in order to maximize the ability to be folded into a portable configuration while still offering the desired coefficient of friction properties described above, the changing pad 20 of the present invention presents a suitable drape friction index. The drape friction index reflects the flexibility of an absorbent article in view of its non-slip characteristics and may be obtained by the drape friction test method described herein. For example, as discussed above, many of the known methods of achieving a desired coefficient of friction requires the addition of layers, coatings, adhesives or the like that can impede the flexibility of the article. Conversely, the changing pads 20 of the present invention advantageously provide both flexibility and non-slip attributes. As such, in one aspect the changing pad 20 of the present invention may define a drape friction index of less than 10 cm as determined by the drape friction index test method set forth herein. In another aspect, the changing pad 20 of the present invention may define a drape friction index of less than 8 cm as determined by the drape friction index test method set forth herein. In still another aspect, the changing pad 20 of the present invention may define a drape friction index of less than 6 cm as determined by the drape friction index test method set forth herein. In still yet another aspect, the changing pad 20 of the present invention may define a drape friction index of less than 5.5 cm as determined by the drape friction index test method set forth herein. Alternatively, the changing pad 20 of the present invention may define a drape friction index of between 4.0 cm and 6.0 cm as determined by the drape friction index test method set forth herein.

The ability of the changing pad to be folded is also impacted by the thickness 36 of the changing pad 20. Therefore, in order to assist in minimizing the folded surface area of the changing pad 20, the thickness 36 of the changing pad may be maintained in a desired range while still maintaining suitable absorbent performance of the absorbent layer 24 as discussed in greater detail below. Specifically, the thickness of the changing pad may be between 0.8 mm and 1.2 mm.

Optionally, the changing pad 20 of the present invention may also include at least one folding indicator (not shown). A folding indicator may include indicia that are merely printed upon either the inner surface 40 or outer surface 42 of the changing pad 20. As such, the folding indicia can provide the caregiver guidance on how to layer the product to obtain the desired folded configuration. Alternatively, the folding indicator may consist of a series of creases that are placed in the product that, as well as providing direction, eases the folding process for the caregiver. In yet another alternative, the folding indicator can consist of a series of stitches, perforations, ultrasonic bond lines, and the like or combinations thereof. Desirably, the changing pad 20 may include a plurality of folding indicators to maximize their effectiveness.

As mentioned above, the changing pad 20 of the present invention includes a film layer 22 and an absorbent layer 24. The layers 22 and 24 may be directly or indirectly joined together using suitable means as are well known in the art. For example, the absorbent layer 24 may be joined directly to the film layer by an adhesive. Such adhesives may be applied by spraying, slot coating, or other methods, and combinations thereof. In one aspect, the layers 22 and 24 are joined together using a hot melt adhesive applied in a swirl pattern. Suitable hot melt adhesives may be obtained from Findley Adhesive, a company having an office in Durham, N.C. under the designation H2525a, and may be applied at a basis weight of about 1.6 gsm. Alternatively, the absorbent layer 24 may be joined directly to the film layer by ultrasonic bonding, heat welds, stitching, mechanical attachment, or combinations thereof.

The film layer 22 of the present invention 20 may either be liquid permeable or liquid impermeable. It is generally preferred that the film layer 22 be formed substantially impermeable to liquids. Thus, the film layer 22 may be manufactured from a thin plastic film or other flexible liquid-impermeable material. If it is desired to present the film layer 22 with a more clothlike feeling, the film layer may comprise a polyolefin film having a nonwoven web laminated to the outer surface thereof, such as a spunbond web of polyolefin fibers. Methods of forming such clothlike outer covers are known to those skilled in the art. Further, the film layer 22 may optionally be composed of a micro-porous “breathable” material which permits vapors to escape from the absorbent layer 24 while still preventing liquid exudates from passing through.

In a particular aspect, the film layer 22 may be provided by a liquid impermeable polyethylene film having a thickness of 1.0 mil and a basis weight of about 45 gsm. The polyethylene film may further include a blend of resins to provide the changing pad with the desired coefficient of friction. Suitable resins include, but are not limited to vinyl acetates, methyl acrylates, and polyolefin plastomers. One such film may be obtained from Pliant Corporation having an office in Chippewa Falls, Wis. under the designation of film XC2-22-1645.3.

The absorbent layer 24 of the changing pad 20 of the present invention may be formed from any suitable absorbent material such as natural or synthetic fibers, cellulose, foams, superabsorbent particles, and combinations thereof. In a particular embodiment, the absorbent structure can be a unitary or single-ply fibrous web having a laminate-like structure. This structure may consist of a soft, absorbent central core region of relatively low fiber concentration sandwiched between two strong, abrasion resistant surface regions of high fiber concentration. The surface regions may include bonding material to provide strength to the web. Desirably, this bonding material may be elastomeric. The relatively low fiber concentration within the central core region provides space to increase the absorbency of the web. Within the central core region and extending entirely through the web are networks of fibers that generally connect the two surface regions together without the use of bonding material. The bonding material in at least one surface region may be disposed of in a fine, spaced-apart pattern, and the bonded portions in that surface region may be finely creped to soften them. Such an absorbent structure is described as a double recreped fiberous web (DRC) and is further disclosed in U.S. Pat. No. 5,674,590 issued Oct. 7, 1997 to Anderson et al., the disclosure of which is hereby incorporated by reference. In a particular aspect, the absorbent layer may be a DRC having a basis weight of between 80 gsm and 90 gsm, and more particularly about 86 gsm.

Advantageously, the absorbent layer may provide a suitable level of absorbent capacity to the changing pad 20 while still allowing the changing pad 20 to maintain a desired level of thickness 36, as discussed above. In one aspect, the absorbent layer 24 may provide an absorbent capacity of at least 0.05 grams/cm² as determined by the absorbent capacity test set forth herein. In another aspect, the absorbent layer 24 may provide an absorbent capacity of at least 0.07 grams/cm² as determined by the absorbent capacity test set forth herein. Alternatively, the absorbent layer 24 may provide an absorbent capacity of between 0.05 grams/cm² and 1.2 grams/cm².

The different aspects of the present invention advantageously provide a changing pad 20 that has a secure, non-slip outer surface 42 having a static coefficient of friction of at least 0.5. As such, the changing pad 20 is particularly suited for use when caring for a baby or child in a mobile environment. The present invention also advantageously includes an absorbent layer 24 that may reduce the instance of runoff of liquid exudates and may reduce the need to clean up the surrounding area. In addition, the present invention may provide a particular absorbent capacity while maintaining a thickness 36 that is between 0.8 mm and 1.2 mm. As such, the present invention may advantageously provide the desired absorbent attributes while remaining highly foldable and thus portable. Moreover, this benefit may be enhanced by the low drape stiffness of the present invention, which further increases the ability of the caregiver to reduce the article's size when not in use. Thus, the present invention provides a changing pad 20 that provides a non-slip outer surface 42, a suitable absorbent layer 24, and that may be greatly reduced in size by folding for improved portability.

Suitable techniques for demonstrating the improved qualities of the present invention are set forth below in the “Testing” section of the present disclosure.

Test Methods

For the tests described below, the following products and examples were used:

PEE WEES, available from Kid-ding, a division of Continental Quilting Company, Inc., having offices in Brooklyn, N.Y.

BARNA disposable changing pads, available from Barna Limited, having offices in Naperville, Ill.

PAD'EMS disposable changing pads, available from Disposable Products Corporation, having offices in Coral Gables, Fla.

PAMPERS Changing Mats, available from Procter & Gamble UK having offices in Egham, Surrey, England.

### EXAMPLE 1

An absorbent article including the following:

A 1.0 mil film layer having a basis weight of about 45 gsm available from Pliant Corporation having an office in Chippewa Falls, Wis. under the designation of film XC2-22-1645.3.

An 86 GSM DRC absorbent layer available from Kimberly-Clark Corporation, a company having offices in Neenah, Wis.

The film layer and the absorbent layer were joined using Airflex 426 binder applied at a basis weight of about 1.6 gsm. The adhesive is available from Air Products and Chemicals, Inc., a company having an office in Allentown, Pa.

The surface dimensions of Example 1 when open were 760 mm×502 mm. The surface dimensions of Example 1 when folded were 100 mm×155 mm.

Coefficient of Friction (COF)

This test is used to measure the static COF of the outer surface 24 of the absorbent article. The procedure determines the initial (static) friction of a material when beginning to slide over another material. A sled, which has the test specimen attached, is pulled over a platen (table) which has a representative surface material (the metal surface of the instrument) or a representative surface material attached. The test specimen and material on the platen are in surface-to-surface contact with each other. The COF is defined as the measure of the relative difficulty when the surface of one material starts to slide over an adjoining surface of either itself or of another material. The static COF represents the maximum COF values obtained during the first inch (2.54 cm) of specimen travel distance at a testing rate of 15.25 cm/min.

The following apparatus and material are required: Coefficient of Friction tester TMI Model 32-90 and Testing-Sled B with foam 200±5.0 grams both obtained form Testing Machines, Inc., Islanda, N.Y.

The test specimens are prepared as follows: Care must be taken in handling the specimens. The test surface must be kept free of all dust, lint, fingerprints, or any foreign matter that might change the surface characteristic of the absorbent article. Identify and mark the machine direction on the test side of the specimen. For whole products the longest dimension of the product was considered the machine direction (MD), the shorter dimension of the product was considered the cross direction (CD). Cut the sled specimen from the absorbent article 120±1 mm in the machine direction (MD) and 67±1 mm in the cross direction (CD).

The specimens are tested as follows: Conduct the testing in an atmosphere of 230°±2° C. and 50±2% relative humidity. Condition all specimens a minimum of 24 hours prior to testing. Calibrate the COF tester according the manufacturer's directions. Set the travel distance to 15 cm and set the travel speed to 15.25 cm/min. Set the COF tester display to read grams and zero the display. The absorbent article specimen with the outer surface 24 exposed is mounted to the test sled using clamps on the sled. The longer dimension is engaged in the clamps which are at either end of the sled. Ensure the surfaces of the test specimen and test bed materials are not contaminated during mounting. The sled is positioned very lightly and gently on the surface of the platen to prevent any unnatural bond from developing between the absorbent article and the surface of the platen. Start the test by pressing the TEST key on the COF tester.

The results are calculated and displayed by the COF tester. The COF tester records the “STATIC” value for the highest instantaneous coefficient of friction value obtained to begin the movement between the surfaces within the first inch of pull. The COF tester also records the “KINETIC” value obtained from the average of the values obtained during the 60 seconds of the test (15 cm travel distance). The calculation for “STATIC” coefficient of friction is obtained by the tester using the following equation: μₛ=Aₛ/B, where μₛ=the static coefficient of friction value, Aₛ=the maximum initial gram value obtained within the first inch of movement, and B=sled weight of about 200 grams. Three samples were tested per product.

Absorbent Capacity

As used herein, “absorbent capacity” is the grams of distilled water retained by the absorbent article. Absorbent capacity is determined by conditioning the test samples in a standard laboratory atmosphere of 23±1° C. and 50±2% RH for at least 24 hours prior to testing the sample. All testing is conducted under the standard laboratory conditions. Cut a 4 inch by 4 inch sample from the absorbent article. Weigh the sample to the nearest 0.01 gram and place in a bath of distilled water. Allow the sample to soak for 3 minutes (±5 seconds) ensuring an excess amount of water is present in the bath to completely saturate the sample. After 3 minutes, remove the sample and hang it from a clamp in a diamond shape so that one corner is lower than the rest of the specimen. Allow the sample to drain for 3 minutes (±5 seconds). After 3 minutes, remove the sample from the clamp and weigh to the nearest 0.01 gram. Calculate the absorbent capacity (grams per 4 in by 4 inch sample) by subtracting the dry sample weight from the saturated sample weight. This is converted to grams per square centimeter by dividing by a 103.2 conversion factor. Three samples were tested per product.

The Pampers Change Mat has a patterned absorbent area. Three samples were cut from this product, one each from opposite corners of the product and one offset from the center to obtain a more random average of the article, based on the pattern of absorbent material.

Thickness

The thickness of the absorbent article is determined at a pressure of 0.2 psi (1.4 kPa) using a platen that is 3 inches (7.6 cm) in diameter. Testing equipment should be located in, and samples conditioned to, an atmosphere of 23±2° C. and 50±2% relative humidity. The absorbent article is tested after being conditioned to the test conditions for a minimum of 24 hours. The thickness is reported to the nearest 0.01 mm for each sample, and the average of three samples is used as the thickness of the absorbent article.

Drape Stiffness

Drape Stiffness is tested using ASTM Standard Test D 1388 “Stiffness of Fabrics.” The specimen size for this test is changed from 1″×6″ (2.54 cm×15.24 cm) to 1″ by 8″ (2.5 cm×20.3 cm). Otherwise, the test method outlined in ASTM D 1388 is followed. A summary of the test method follows.

The test determines the bending length of an absorbent article or fabric, using the principle of cantilever bending of the specimen under its own weight. This method measures the drape stiffness or resistance to bending of the specimen. The bending length is a measure of the interaction between specimen weight and specimen stiffness as shown by the way in which a specimen bends under its own weight. This is a reflection of the stiffness of the specimen when bent in one plane under the force of gravity.

The 1″×8″ (2.5 cm×20.3 cm) specimen is slid, at 4¾ in. per minute (12.1 cm/min), in a direction parallel to its long dimension, so that its leading edge projects from the edge of a horizontal surface. The length of the overhang is measured when the tip of the specimen is depressed under its own weight to the point where the line joining the tip to the edge of the platform makes a 41.5° angle with the horizontal. The longer the overhang the slower the specimen was to bend; thus, higher numbers indicate a stiffer specimen.

The following apparatus and materials are required: FRL-Cantilever Bending Tester, Model 79-10 available from Testing Machines Inc, 400 Bayview Avenue, Amityville, N.Y. 11701; Cuffing Press with 1″×8″ (2.5 cm×20.3 cm) rectangular cutting die.

The specimen should be prepared as follows: Testing equipment should be located in, and samples conditioned to, an atmosphere of 23±2° C. and 50±2% relative humidity. Handle the specimens as little as possible to avoid getting oil, grease, water, etc. on them, which would bias the test results. In particular, avoid touching the surface of the specimens. For whole products the longest dimension of the product was considered the machine direction (MD), the shorter dimension of the product was considered the cross machine direction (CD). The Pampers product which was primarily square product, the MD was “head to toe” with the printed graphic figures. Specimens should be evenly spaced across the cross directional width of the sample. Cut 5 specimens in each of the machine and cross directions from each sample; i.e., a total of 10 specimens are tested for each sample. Specimens should be cut from areas free of folds when possible.

For the Pampers Change Mats, the patterned absorbent required the dissimilar areas to be tested separately. These are reported as the “absorbent area” and “non absorbent area” of the changing mat. The absorbent area was cut from near the edge of the product where there was a long enough strip of fluff and superabsorbent containing absorbent that was sandwiched between a topsheet and backsheet. The non absorbent area was cut from the adjacent area to the absorbent area where there was substantially no fluff and superabsorbent containing absorbent between the topsheet and backsheet.

Testing of the Pad'ems code was not conducted.

The specimens should be tested as follows: Calibrate the test equipment according to the manufacture's directions prior to testing the specimens. After lifting the movable slide up, place the specimen on the stationary table with the coated side up. The length of the specimen should be parallel to the edge of the table. The edge of the specimen should be aligned with the line scribed ¼″ from the right hand edge of the table. Lower the movable slide back onto the stationary table being careful not to move the specimen. Verify that the bend angle indicator is at the 41.5° angle marked on the scale. Turn the On/Off switch ON. Watch the leading edge of the specimen closely. Turn the switch OFF the instant that the edge of the specimen touches the knife-edge. Read and record the overhang length from the linear scale. Test remaining specimens following the above procedure.

The results of the test are reported as follows: Report the bending length recorded for each individual specimen. Specimens cut MD and CD are considered different and their results should be reported separately. Calculate the average of the bending length for the five specimens in each direction. This is the absorbent article bending length for that direction. Calculate the drape stiffness of the absorbent article in each direction according to the following equation:

$$\text{Drape Stiffness (cm)} = \frac{\text{bending length (cm)}}{2}$$

Drape Friction Index

The Drape Friction index is obtained according to the following equation:

$$\text{Drape Friction (cm)} = \frac{\text{Drape Stiffness (cm)}}{\text{Static} \text{COF}}$$

The drape stiffness of either the MD or CD may be used.

Results:

TABLE 1
Thickness, Absorbent Capacity and Coefficient of Friction

| | | Absorbent | | |
|---|---|---|---|---|
| | | Capacity | Static | Kinetic |
| | Thickness (mm) | (g/cm²⁾ | COF | COF |
| Example 1 | 0.88 | 0.083 | 0.947 | 0.876 |
| Pee-Wees | 0.41 | 0.023 | 0.243 | 0.208 |
| Barna Changing Pads | 0.36 | 0.020 | 0.253 | 0.186 |
| Pad'ems | 0.76 | 0.083 | 0.230 | 0.177 |
| PAMPERS Change Mats | 1.26 | 0.268 | 0.394 | 0.323 |

TABLE 2
Drape Stiffness and Drape Friction Index

| | CD Drape | CD Drape | MD Drape | MD Drape |
|---|---|---|---|---|
| | Stiffness | Friction Index | Stiffness | Friction Index |
| | (cm) | (cm) | (cm) | (cm) |
| Example 1 | 5.06 | 5.34 | 3.09 | 3.26 |
| Pee-Wees | 3.97 | 16.33 | 2.78 | 11.44 |
| Barna | 3.59 | 14.19 | 3.14 | 12.41 |
| Changing Pads | | | | |
| Pad'ems | — | — | — | — |
| PAMPERS | 3.35/2.29 | 8.50/5.81 | 3.72/2.81 | 9.44/7.13 |
| Change Mats | | | | |
| (absorbent | | | | |
| area/non | | | | |
| absorbent | | | | |
| area) | | | | |

Having described the invention in rather full detail, it will be readily apparent that various changes and modifications can be made without departing from the spirit of the invention. All of such changes and modifications are contemplated as being within the scope of the invention as defined by the subjoined claims.

We claim:

1. A disposable absorbent article defining an inner surface and an outer surface, said disposable absorbent article comprising:
an absorbent layer disposed toward said inner surface;
a film layer adjacent said absorbent layer;
wherein said film layer provides at least a portion of said outer surface of said disposable absorbent article with a static coefficient of friction of at least 0.5 as defined by the coefficient of friction test set forth herein.

2. The disposable absorbent article of claim 1 wherein said static coefficient of friction is at least 0.9.

3. The disposable absorbent article of claim 1 wherein said static coefficient of friction is between 0.7 and 1.5.

4. The disposable absorbent article of claim 1 wherein said absorbent layer provides an absorbent capacity of between 0.05 g/cm² and 1.2 g/cm² as defined by the absorbent capacity test set forth herein.

5. The disposable absorbent article of claim 4 further defining a thickness dimension wherein said thickness dimension is between 0.8 mm and 1.2 mm.

6. The disposable absorbent article of claim 1 further defining a CD drape stiffness of less than 6.0 cm as defined by the drape stiffness test set forth herein.

7. The disposable absorbent article of claim 1 and further comprising at least one folding indicator.

8. The disposable absorbent article of claim 1 further defining an open surface area and a folded surface area wherein said folded surface area is less than 10% of said open surface area when said disposable absorbent article is in a folded configuration.

9. The disposable absorbent article of claim 8 wherein said folded surface area is less than 5% of said open surface area.

10. The disposable absorbent article of claim 8 wherein said open surface area is at least 560 square inches.

11. The disposable absorbent article of claim 1 wherein said absorbent layer is a DRC.

12. The disposable absorbent article of claim 1 wherein said film layer is operatively liquid impermeable.

13. The disposable absorbent article of claim 1 wherein said film layer defines a first surface and a second surface and wherein said film layer provides said static coefficient of friction on at least said first surface.

14. The disposable absorbent article of claim 1 wherein said absorbent layer is joined directly to said film layer by an adhesive.

15. The disposable absorbent article of claim 1 wherein said absorbent layer is jointed directly to said film layer by ultrasonic bonding.

16. A disposable changing pad defining an inner surface and an outer surface, said changing pad comprising:
an absorbent layer disposed toward said inner surface;
a film layer adjacent said absorbent layer;
wherein said film layer provides at least a portion of said outer surface of said changing pad with a static coefficient of friction of at least 0.5 as defined by the coefficient of friction test set forth herein, and said changing pad defines a CD drapestiffness of less than 6.0 cm as defined by the drape stiffness test set forth herein.

17. The changing pad of claim 16 wherein said static coefficient of friction is at least about 0.9.

18. The changing pad of claim 16 wherein said static coefficient of friction is between 0.7 and 1.5.

19. The changing pad of claim 16 wherein said absorbent layer provides an absorbent capacity of between 0.05 g/cm² and 1.2 g/cm² as defined by the absorbent capacity test set forth herein.

20. The changing pad of claim 19 further defining a thickness dimension wherein said thickness dimension is between 0.8 mm and 1.2 mm.

21. The changing pad of claim 16 and further comprising at least one folding indicator.

22. The changing pad of claim 16 further defining an open surface area and a folded surface area wherein said folded surface area is less than 10% of said open surface area when said changing pad is in a folded configuration.

23. The changing pad of claim 22 wherein said folded surface area is less than 5% of said open surface area.

24. The disposable absorbent article of claim 22 wherein said open surface area is at least 560 square inches.

25. The changing pad of claim 16 wherein said absorbent layer is a DRC.

26. The changing pad of claim 16 wherein said film layer is operatively liquid impermeable.

27. The changing pad of claim 16 wherein said film layer defines a first surface and a second surface and wherein said film layer provides said static coefficient of friction on at least said first surface.

28. The changing pad of claim 16 wherein said absorbent layer is joined directly to said film layer by an adhesive.

29. The changing pad of claim 16 wherein said absorbent layer is jointed directly to said film layer by ultrasonic bonding.

30. A disposable changing pad defining an inner surface and an outer surface, said changing pad comprising:
an absorbent layer disposed toward said inner surface;
a film layer adjacent said absorbent layer;
wherein said film layer provides at least a portion of said outer surface of said changing pad with a static coefficient of friction of at least 0.5 as defined by the coefficient of friction test set forth herein, said outer surface of the changing pad defines a planar continuity of at least 90%, and said changing pad defines a CD drape stiffness of less than 6.0 cm as defined by the drape stiffness test set forth herein.

31. A disposable changing pad defining an inner surface and an outer surface, said changing pad comprising:
an absorbent layer disposed toward said inner surface;
a film layer adjacent to said absorbent layer and disposed toward said outer surface;
wherein said changing pad defines a drape friction index of less than 6 cm as determined by the drape friction index test set forth herein.

32. The changing pad of claim 16 further defining an open surface area of at least 250 square inches.
